(19) United States
(12) Patent Application Publication
(10) Pub. No.: US 2025/0067292 A1
(43) Pub. Date: Feb. 27, 2025

(54) CONNECTOR FOR FIXING LAMINATE BETWEEN TWO VERTICAL PLATES

(71) Applicant: Lusterful Science and Technology Co., Ltd., Qingyuan (CN)

(72) Inventor: Weiming LIU, Qingyuan (CN)

(21) Appl. No.: 18/655,300

(22) Filed: May 5, 2024

(30) Foreign Application Priority Data
Aug. 23, 2023 (CN) 202322275395.3

(51) Int. Cl. F16B 5/02

(52) U.S. Cl. CPC F16B 5/0266

(57) ABSTRACT

A connector for fixing a laminate between two vertical plates, including: a sleeve, a connecting rod, an embedded part, a rear cover, and a compression spring. The inner wall of the sleeve includes a limit step. The connecting rod is disposed in the sleeve and includes a first end and a second end. The first end includes a stop part matched with the limit step. The second end extends out of the sleeve. The rear cover is detachably disposed on the rear end of the sleeve. The compression spring is disposed in the sleeve and includes a third end abutting against the rear cover and a fourth end abutting against the stop part; and the embedded part includes an embedded nut and a fastener. The fastener is detachably disposed in the embedded nut and is connected to the second end of the connecting rod.

### CROSS-REFERENCE TO RELATED APPLICATIONS

Pursuant to 35 U.S.C.§ 119 and the Paris Convention Treaty, this application claims foreign priority to Chinese Patent Application No. 202322275395.3 filed Aug. 23, 2023, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, MA 02142.

### BACKGROUND

The disclosure relates to a connector for fixing a laminate between two vertical plates.

Conventional connectors include a connecting rod and an expansion sleeve sleeving the connecting rod, for the connection of side plates (vertical plates) and laminates (horizontal plates). During installation, one end of the expansion connector is first inserted into a laminate, and then the laminate is approached perpendicularly to a side plate so that the other end of the expansion connector is installed into the side plate, thus achieving the connection of the laminate and the side plate. The connector cannot be used to fix a laminate between two vertical plates, and the connection between a laminate and a vertical plate with the connector is not firm.

### SUMMARY

One objective of the disclosure is to provide a connector for fixing a laminate between two vertical plates, and the installation process is easy to operate with high firmness.

The disclosure provides a connector for fixing a laminate between two vertical plates, comprising: a sleeve, a connecting rod, an embedded part, a rear cover, and a compression spring. The sleeve is hollow and comprises two open ends; an inner wall of the sleeve comprises a limit step; the connecting rod is disposed in the sleeve and comprises a first end and a second end; the first end comprises a stop part matched with the limit step; the second end extends out of the sleeve; the rear cover is detachably disposed on a rear end of the sleeve; the compression spring is disposed in the sleeve and comprises a third end abutting against the rear cover and a fourth end abutting against the stop part; and the embedded part comprises an embedded nut and a fastener; the fastener is detachably disposed in the embedded nut and is connected to the second end of the connecting rod.

In a class of this embodiment, the rear end of the sleeve comprises a hole, and the rear cover comprises a buckle matched with the hole.

In a class of this embodiment, the sleeve comprises a front end surface comprising a first unidirectional reverse thread.

In a class of this embodiment, the fastener comprises a blind nut and a locking nut; the locking nut is disposed in the blind nut; and the blind nut is detachably disposed in the embedded nut.

In a class of this embodiment, the embedded nut comprises a limiting buckle for limiting the blind nut so that the bind nut is stably located in the embedded nut.

In a class of this embodiment, an outer surface of the embedded nut comprises a second unidirectional reverse thread.

In a class of this embodiment, a convex bar is disposed on the inner wall of the sleeve between the rear cover and the limit step; the stop part comprises a groove; and the convex bar is matched with the groove to guide the connecting rod to move axially.

The following advantages are associated with the connector for fixing a laminate between two vertical plates of the disclosure: the combination of the sleeve, the connecting rod, and the embedded part of the connector allows for the connection of a laminate (horizontal plate) with two vertical side plates; the installation is convenient and firm, and is a hidden connection.

### BRIEF DESCRIPTION OF THE DRAWINGS

FIG. 1 is a schematic diagram of a connector for fixing a laminate between two vertical plates in accordance with one embodiment of the disclosure;

FIG. 2 is an exploded view of a connector for fixing a laminate between two vertical plates in accordance with one embodiment of the disclosure;

FIG. 3 is a cross sectional view of a sleeve in accordance with one embodiment of the disclosure; and

FIG. 4 is a sectional view of a combination of a laminate (horizontal plate) with two vertical side plates in accordance with one embodiment of the disclosure.

### DETAILED DESCRIPTION

To further illustrate the disclosure, embodiments detailing a connector for fixing a laminate between two vertical plates are described below. It should be noted that the following embodiments are intended to describe and not to limit the disclosure.

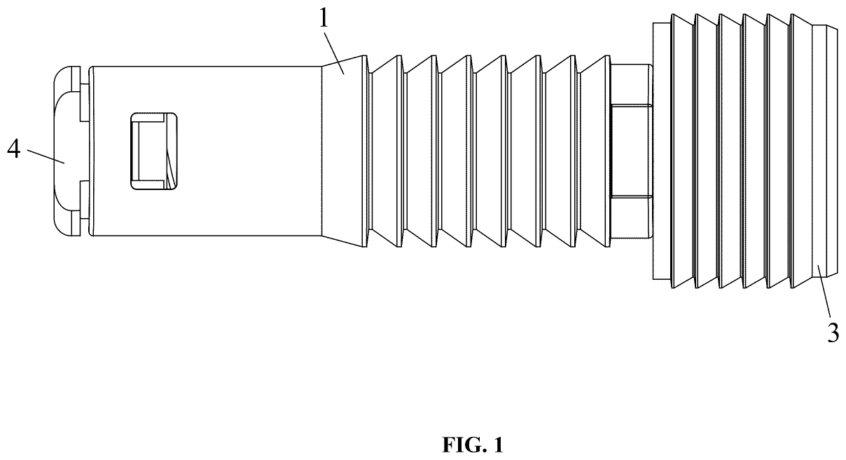

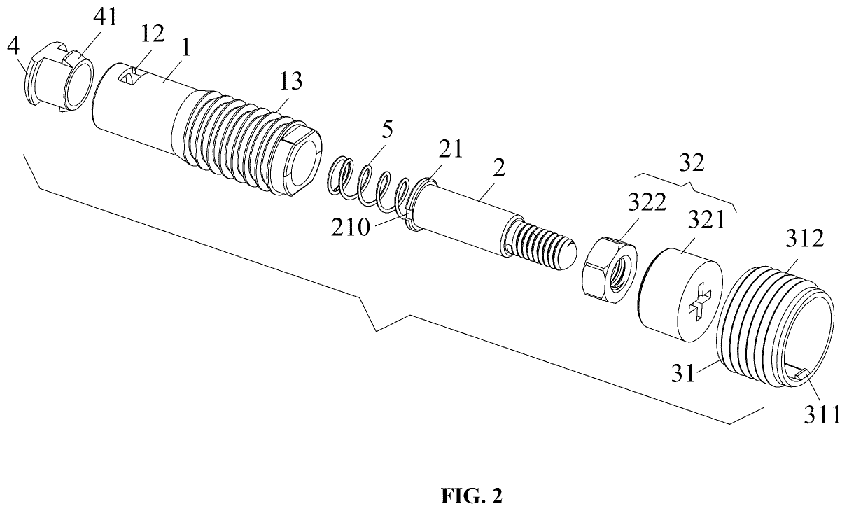

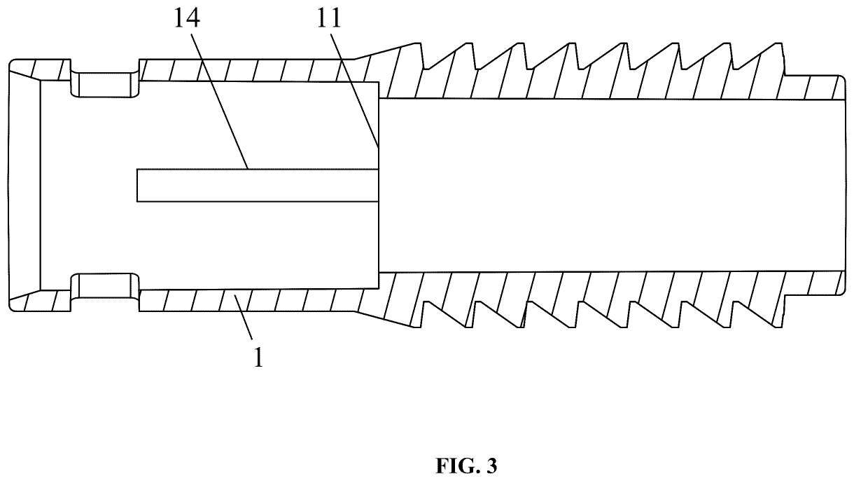

As shown in FIGS. 1-3, the disclosure provides a connector for laminates comprising: a sleeve 1, a connecting rod 2, an embedded part 3, a rear cover 4, and a compression spring 5. The sleeve 1 is hollow and comprises two open ends; the inner wall of the sleeve 1 comprises a limit step 11; the connecting rod 2 is disposed in the sleeve 1 and comprises a first end, a middle part, and a second end; the first end comprises a stop part 21 matched with the limit step 11; the middle part is the rod body; the second end comprises a threaded part. The diameter of the stop part 21 is larger than the diameter of the rod body. The diameter of the threaded part is smaller than the diameter of the rod body. The threaded part extends out of the sleeve 1. The rear cover 4 is detachably disposed on a rear end of the sleeve 1. The compression spring 5 is disposed in the sleeve 1 and comprises a third end abutting against the rear cover and a fourth end abutting against the stop part 21. The diameter of the compression spring 5 is larger than that of the stop part 21 and less than that of the sleeve 1. The embedded part 3 comprises an embedded nut 31 and a fastener 32; the fastener 32 is detachably disposed in the embedded nut 31 and is connected to the threaded part of the connecting rod 2. A convex bar 14 is disposed on the inner wall of the sleeve 1 between the rear cover 4 and the limit step 11. The convex bar 14 has a guiding effect and fits with a groove 210 radially disposed on the stop part 21, causing the stop part 21 to move up and down along the convex bar 14, so that the connecting rod 2 and the stop part 21 move steadily axially during the deformation process of the compression spring.

The rear end of the sleeve 1 comprises a hole 12, and the rear cover 4 comprises a buckle 41 matched with the hole 12, thus facilitating the detachment of the rear cover from the sleeve. The sleeve 1 comprises a front end surface comprising a first unidirectional reverse thread 13. In the mounting process, the first unidirectional reverse thread 13 is smoothly screwed into a laminate without obstruction; to pull out the sleeve, the friction between the first unidirectional reverse thread and the laminate requires to be overcome, which is difficult, thus improving the stability of the installation of the laminate.

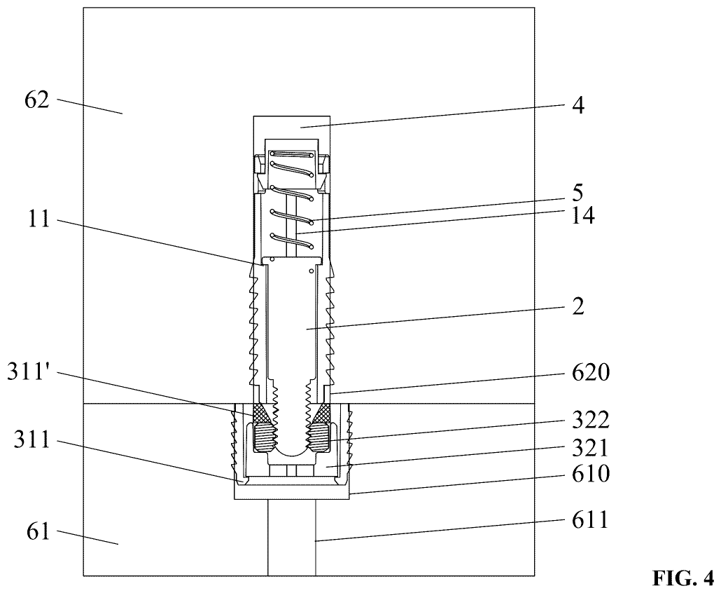

The fastener 32 comprises a blind nut 321 and a locking nut 322; the locking nut 322 is disposed in the blind nut 321. The internal structure of the blind nut 321 is designed to match the external shape of the locking nut 322, which can be a hexagonal nut or other types of nuts. The external structure of the blind nut 321 is cylindrical, with one end open and the other end closed. The center of the closed end comprises a cross hole that can be inserted with a tool such as an electric screwdriver to twist the embedded part to lock the side plate of the laminate. The cross hole can be replaced by a straight hole, or a hexagonal hole. The blind nut 321 is detachably disposed in the embedded nut 31. One end of the embedded nut 31 is open, and the other end is provided with a limiting buckle 311 for limiting the blind nut so that the bind nut is stably located in the embedded nut. The center part of the blind nut 321 is a counter bore (countersunk hole). The outer surface of the embedded nut 31 comprises a second unidirectional reverse thread 312, which has the same function as the first unidirectional reverse thread. Specifically, the first unidirectional reverse thread 13 is disposed on the front surface of the sleeve 1. When the sleeve 1 enters a mounting hole position, as shown in FIG. 4, the profile of the first unidirectional reverse thread 13 is conical, so that the sleeve is easy to enter the mounting hole position. The conical bottom surface is stuck on the wall, so it is difficult to pull out the sleeve. The direction of the second unidirectional reverse thread 312 on the embedded nut 31 entering the mounting hole position and the thread direction are opposite to the first unidirectional reverse thread 13, so that is it also difficult to pull the embedded nut 31 out of the mounting hole position on the lower panel. And the two plates of the two mounting hole are connected through the connecting rod 2.

Optionally, both ends of the embedded nut 31 are open, and the limit mechanisms are disposed at the openings to limit the blind nut 321 to rotate within the cavity of the embedded nut 31. The opening of one end of the embedded nut 31 receives the extension end of the connecting rod 2, and the limit mechanism 311′ is disposed circumferentially or symmetrically on the open end. The limiting buckle 311 is symmetrically or circumferentially disposed at the other end of the embedded nut 31, and is a unidirectional chamfered structure used for the blind nut 321 to slide unidirectionally into the cavity of the embedded nut 31 along the limit buckle 311.

When installing, first, first holes 610 are respectively preset in a first laminate 61 and a second laminate. The embedded part is placed in the hole of the first laminate, and the sleeve 1 and the connecting rod 2 are disposed in the second hole 620 of the second laminate 62. Combine the first laminate and the second laminate, and the threaded end of the connecting rod 2 is inserted in the embedded part 3. Turn the embedded part 3 by an electric screwdriver through a blind hole 611 to lock the connecting rod 2, thus achieving the installation of the first laminate and the second laminate.

Optionally, the embedded part 3 can also be installed in the side plate, and the sleeve 1 and connecting rod 2 can be correspondingly installed in the horizontal plate.

The combination of the sleeve 1, the connecting rod 2, and the embedded part 3 of the connector allows for the connection of a laminate (horizontal plate) with two vertical side plates; the installation is convenient and firm, and is a hidden connection.

It will be obvious to those skilled in the art that changes and modifications may be made, and therefore, the aim in the appended claims is to cover all such changes and modifications.

What is claimed is:

1. A connector for fixing a laminate between two vertical plates, the connector comprising:
a sleeve;
a connecting rod;
an embedded part;
a rear cover; and
a compression spring;
wherein:
the sleeve is hollow and comprises two open ends; an inner wall of the sleeve comprises a limit step;
the connecting rod is disposed in the sleeve and comprises a first end and a second end; the first end comprises a stop part matched with the limit step; the second end extends out of the sleeve;
the rear cover is detachably disposed on a rear end of the sleeve;
the compression spring is disposed in the sleeve and comprises a third end abutting against the rear cover and a fourth end abutting against the stop part; and
the embedded part comprises an embedded nut and a fastener; the fastener is detachably disposed in the embedded nut and is connected to the second end of the connecting rod.

2. The connector of claim 1, wherein the rear end of the sleeve comprises a hole, and the rear cover comprises a buckle matched with the hole.

3. The connector of claim 2, wherein the sleeve comprises a front end surface comprising a first unidirectional reverse thread.

4. The connector of claim 3, wherein the fastener comprises a blind nut and a locking nut; the locking nut is disposed in the blind nut; and the blind nut is detachably disposed in the embedded nut.

5. The connector of claim 4, wherein the embedded nut comprises a limiting buckle for limiting the blind nut so that the bind nut is stably located in the embedded nut.

6. The connector of claim 5, wherein an outer surface of the embedded nut comprises a second unidirectional reverse thread.

7. The connector of claim 1, wherein a convex bar is disposed on the inner wall of the sleeve between the rear cover and the limit step; the stop part comprises a groove; and the convex bar is matched with the groove to guide the connecting rod to move axially.
